(19) United States
(12) Patent Application Publication
(10) Pub. No.: US 2026/0278426 A1
(43) Pub. Date: Sep. 17, 2026

(54) COMMUNICATION SUPPORT DEVICE, COMMUNICATION SUPPORT METHOD, AND RECORDING MEDIUM FOR DECISION MAKING

(71) Applicant: NEC Corporation, Tokyo (JP)

(72) Inventor: You YOSHIDA, Tokyo (JP)

(73) Assignee: NEC Corporation, Tokyo (JP)

(21) Appl. No.: 19/430,994

(22) Filed: Dec. 23, 2025

(30) Foreign Application Priority Data
Mar. 17, 2025 (JP) 2025-042730

(51) Int. Cl. G06N 5/046

(52) U.S. Cl. CPC G06N 5/046

(57) ABSTRACT

A communication support device includes, at least one memory storing instructions, and at least one processor configured to execute the instructions to, acquire a content, select, based on a description of the acquired content, a persona model from among the plurality of persona models, the persona model being a trained model that has learned a relationship between an expression in the content and a reaction of a person having a specific attribute in response to the expression, predict, based on the acquired content and the selected persona model, a reaction to the expression in the acquired content, generate, based on a prediction result, an improvement proposal of the expression in the acquired content, and output information regarding the improvement proposal.

This application is based upon and claims the benefit of priority from Japanese Patent Application No. 2025-042730, filed on March 17, 2025, the disclosure of which is incorporated herein in its entirety by reference.

### TECHNICAL FIELD

The present disclosure relates to a communication support device, a communication support method, and a program.

### BACKGROUND ART

There are techniques for analyzing an expression in a content and replacing the expression with an appropriate expression.

For example, JP 2014-071769 A discloses an expression conversion device that controls a dialogue form in which a plurality of speakers appear in accordance with a dialogue partner or a scene.

### SUMMARY

By the way, an expression in a content may cause a recipient to have various feelings. However, in the expression conversion device disclosed in JP 2014-071769 A, it may be difficult to propose an improvement proposal of an expression in consideration of a feeling of a recipient of a content.

An object of the present disclosure is to propose an improvement proposal of an expression in a content in consideration of a feeling of a recipient of the content.

A communication support device according to one aspect of the present disclosure includes an acquisition means for acquiring a content, a selection means for selecting, based on a description of the acquired content, a persona model from among the plurality of persona models, the persona model being a trained model that has learned a relationship between an expression in the content and a reaction of a person having a specific attribute in response to the expression, a prediction means for predicting, based on the acquired content and the selected persona model, a reaction to the expression in the acquired content, a generation means for generating, based on a prediction result, an improvement proposal of the expression in the acquired content, and an output means for outputting information regarding the improvement proposal.

A communication support method according to one aspect of the present disclosure includes acquiring a content, selecting, based on a description of the acquired content, a persona model from among the plurality of persona models, the persona model being a trained model that has learned a relationship between an expression in the content and a reaction of a person having a specific attribute in response to the expression, predicting, based on the acquired content and the selected persona model, a reaction to the expression in the acquired content, generating, based on a prediction result, an improvement proposal of the expression in the acquired content, and outputting information regarding the improvement proposal.

A non-transitory recording medium storing a program for causing a computer to execute processing of, acquiring a content, selecting, based on a description of the acquired content, a persona model from among the plurality of persona models, the persona model being a trained model that has learned a relationship between an expression in the content and a reaction of a person having a specific attribute in response to the expression, predicting, based on the acquired content and the selected persona model, a reaction to the expression in the acquired content, generating, based on a prediction result, an improvement proposal of the expression in the acquired content, and outputting information regarding the improvement proposal.

### BRIEF DESCRIPTION OF THE DRAWINGS

Exemplary features and advantages of the present disclosure will become apparent from the following detailed description when taken with the accompanying drawings in which:

FIG. 1 is a first block diagram illustrating an example of a configuration of a communication support system according to the present disclosure;

FIG. 2 is a first block diagram illustrating an example of a configuration of a communication support device according to the present disclosure;

FIG. 3 is a first example of a screen displayed by a terminal device according to the present disclosure;

FIG. 4 is a second example of the screen displayed by the terminal device according to the present disclosure;

FIG. 5 is a third example of the screen displayed by the terminal device according to the present disclosure;

FIG. 6 is a flowchart illustrating an example of operation of the communication support device according to the present disclosure;

FIG. 7 is a fourth example of the screen displayed by the terminal device according to the present disclosure;

FIG. 8 is a fifth example of the screen displayed by the terminal device according to the present disclosure;

FIG. 9 is a sixth example of the screen displayed by the terminal device according to the present disclosure;

FIG. 10 is a seventh example of the screen displayed by the terminal device according to the present disclosure;

FIG. 11 is an eighth example of the screen displayed by the terminal device according to the present disclosure; and

FIG. 12 is a block diagram illustrating an example of a hardware configuration of the communication support device according to the present disclosure.

### EXAMPLE EMBODIMENT

Hereinafter, example embodiments of the present disclosure will be described in detail with reference to the drawings. In each drawing and each example embodiment described in the specification, similar components will be denoted by the same symbols, and detailed descriptions thereof will not be repeated.

### First Example Embodiment

Hereinafter, a first example embodiment will be described.

### Configuration Example

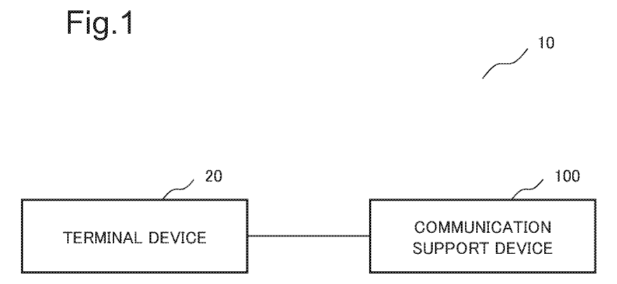

Hereinafter, a configuration example of a communication support system 10 will be described with reference to FIG. 1. FIG. 1 is a block diagram illustrating an example of a configuration of the communication support system 10 according to the present disclosure. The communication support system 10 includes a terminal device 20 and a communication support device 100.

The communication support system 10 is a system that predicts a feeling that can be produced by a recipient of a content with respect to the content and proposes an improvement in a description of the content to a sender of the content.

Here, the content includes at least one of a character, an image, and a voice that the sender intends to transmit or disclose to another person. In one example, the content is a post, an e-mail, a press release, and a handout in a social networking service (SNS). Examples of the content are not limited to those exemplified here.

The terminal device 20 is a terminal device operated by a content sender. For example, the terminal device 20 creates or transmits a content based on an operation received from an operator. Here, in one example, the operator of the terminal device 20 is a content sender.

For example, the terminal device 20 includes an interface that receives an operation from an operator. In one example, the terminal device 20 includes at least one of a touch panel and a physical button. Examples of the interface included in the terminal device 20 are not limited to those exemplified here.

Furthermore, the terminal device 20 includes, for example, a means for providing visual information to the operator. In one example, the terminal device 20 includes a display. An example of the means for providing visual information to the operator provided in the terminal device 20 is not limited to that exemplified here.

In one example, the terminal device 20 is an electronic device such as a smartphone, a tablet terminal, or a personal computer (PC). The examples of the terminal device 20 are not limited to those exemplified here.

The communication support device 100 is a device that predicts a feeling produced by a recipient of a content with respect to the content and proposes an improvement in a description of the content to a sender of the content.

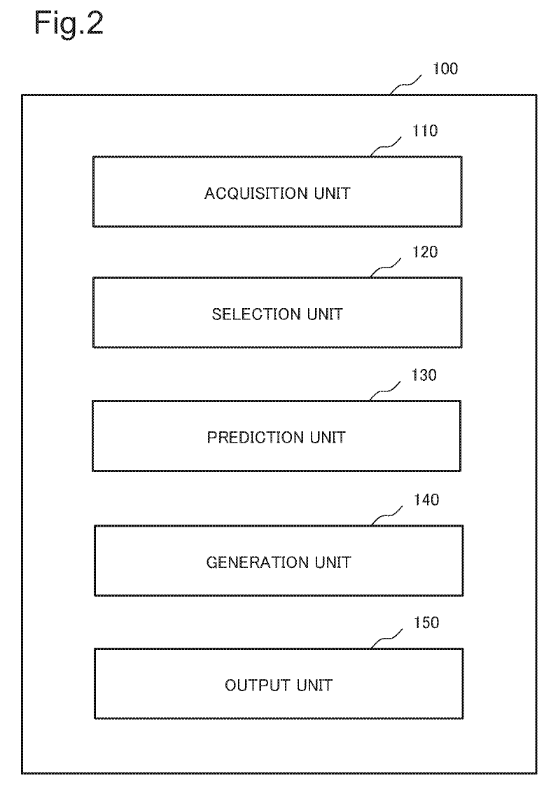

Each configuration of the communication support device 100 will be described with reference to FIG. 2. FIG. 2 is a block diagram illustrating an example of the configuration of the communication support device 100 according to the present disclosure. The communication support device 100 includes an acquisition unit 110, a selection unit 120, a prediction unit 130, a generation unit 140, and an output unit 150. The acquisition unit 110 acquires a content. The selection unit 120 selects a persona model based on the description of an acquired content. The prediction unit 130 predicts a reaction to an expression in the content based on the content and the selected persona model. The generation unit 140 generates an improvement proposal of an expression in a content based on the prediction result. The output unit 150 outputs information regarding the improvement proposal.

First, the acquisition unit 110 will be described.

The acquisition unit 110 acquires a content. For example, the acquisition unit 110 acquires a content from the terminal device 20.

In one example, in a case in which an operation to transmit or publish a content is performed on the terminal device 20, the acquisition unit 110 acquires the content from the terminal device 20.

As a specific example, in a case in which the terminal device 20 receives an operation for posting to the SNS, the acquisition unit 110 acquires a content from the terminal device 20.

As a specific example, in a case in which the terminal device 20 receives an operation of transmitting an electronic mail, the acquisition unit 110 acquires a content from the terminal device 20.

Furthermore, in one example, the acquisition unit 110 acquires a content from the terminal device 20 in a case in which the terminal device 20 receives an operation of requesting a check of the content.

Next, the selection unit 120 will be described.

The selection unit 120 selects a persona model based on the acquired content. For example, the selection unit 120 calculates, based on the description of the content, a degree of fitness of the content with respect to the persona model for each of persona models, and selects the persona model based on the degree of fitness.

Here, the persona model is a trained model obtained that has learned, for each attribute, a relationship between an expression and a reaction of a person having a specific attribute in response to the expression. Here, the expression in the content is an explanatory variable, and the reaction of a person having a specific attribute in response to the expression is an objective variable. In addition, there are a plurality of persona models, and learning is performed on at least one attribute for one persona model.

Here, in one example, the attribute is an attribute possessed by a person. As a specific example, the attribute is at least one of an age, a preference, a life stage, a family structure, a lifestyle, a place of birth, a place of residence, a chronic illness, a religion, and a political ideology. Examples of the attribute are not limited to those exemplified here.

A reaction of a person having a specific attribute in response to an expression is, in one example, a feeling produced by a person having the attribute in response to the use of the expression. Examples of a reaction of a person having a specific attribute in response to an expression are not limited to those exemplified here.

As a specific example, in a case in which “Father's Day” is used as an expression in a content, it is assumed that a person raised in a single-mother family may have negative feelings such as anger and sadness. In this example, the attribute of the person is a “single-mother family”.

Furthermore, as a specific example, in a case in which Chinese characters to be taught in a second-grade or higher student in elementary school are used as an expression in a content, it is assumed that a person who is a first-grade student in elementary school may have a negative feeling that he/she cannot understand the description of the content. In this example, the attribute of the person is a “first-grade student in elementary school”.

Furthermore, as a specific example, in a case in which a mark related to a specific idea is used as an expression in an image content, it is assumed that a person who has an antipathy to the idea may have a negative feeling such as anger.

Furthermore, a reaction of a person having a specific attribute in response to an expression in a content is, for example, a reaction obtained by assuming a reaction of a person having a specific attribute in response to the use of the expression.

A reaction of a person having a specific attribute in response to an expression in a content is, in one example, an indication showing that a person having the attribute may have a negative feeling in response to the use of the expression. As a specific example, in a case in which “Father's Day” is used as an expression in a content, it is assumed that a possibility of causing a person who grew up in a single-mother family to have a negative feeling is pointed out. In this example, the attribute of the person is a “single-mother family”.

A keyword is associated with a persona model. For example, information indicating a keyword is associated with a persona model as metadata. A method of associating a keyword with a persona model is not limited to a method exemplified below.

In one example, a persona model is associated with a keyword related to an attribute of a person to be predicted by the persona model. A keyword related to an attribute of a person indicates, for example, an expression or an event from which a person having the attribute may have a specific feeling.

As a specific example, a persona model in which a person having “single-mother family” as an attribute is a prediction target is associated with “Father's Day”, “father”, “papa”, and the like as keywords.

Furthermore, as a specific example, a persona model in which a person having a “vegan” as an attribute is a prediction target is associated with “pork”, “beef”, “chicken”, and the like as keywords.

In one example, the selection unit 120 compares keywords included in an acquired content with keywords associated with a persona model. The selection unit 120 aggregates the number of keywords associated with the persona model that are included in a content. The selection unit 120 sets the number of keywords associated with the persona model that are included in the content as a degree of fitness of the persona model with respect to the content.

Subsequently, the selection unit 120 selects a persona model whose degree of fitness with respect to the content is equal to or more than a threshold value as a persona model to be applied to the content. The threshold value is appropriately set.

In a case in which a content includes an element in a format other than text, the selection unit 120 may generate the text based on the content of the element. For example, in a case in which a content includes a voice, the selection unit 120 generates a text including a voice transcription. Furthermore, for example, in a case in which a content includes music, the selection unit 120 specifies the name of the music and generates a text indicating the name of the music. Furthermore, for example, in a case in which a content includes an image, the selection unit 120 generates a text indicating the content of the image. A method of generating a text from an element in a format other than text, included in the content, is not limited to the method exemplified here.

Subsequently, the selection unit 120 performs processing of selecting the persona model using the generated text.

With this configuration, the communication support device 100 can narrow down the number of persona models even in a case in which a content other than text is handled.

Next, the prediction unit 130 will be described.

The prediction unit 130 predicts a reaction to an expression in a content based on the content and a persona model. For example, the prediction unit 130 inputs a content to a persona model selected by the selection unit 120, and predicts a reaction of a person having a specific attribute in response to an expression in the content.

In one example, the prediction unit 130 inputs a content to a selected persona model, and predicts an expression from which a person having a specific attribute may have a negative feeling and a reaction of the person having the specific attribute in response to the expression.

Next, the generation unit 140 will be described.

The generation unit 140 generates an improvement proposal of an expression in a content based on the prediction result. For example, the generation unit 140 generates an improvement proposal by inputting the prediction result of the prediction unit 130 to a trained model that has learned a relationship between an expression and an attribute of a person, and an expression obtained by rephrasing the expression so as not to cause the person having the attribute to have a negative feeling.

Here, in one example, the number of keywords may be the number of times keywords appear in the content, or may be types of keywords included in the content. Here, the trained model that has learned the relationship between the attribute of the person and the expression in the content, and the expression obtained by rephrasing the expression so as not to cause the person having the attribute to have a negative feeling may be a single model. Furthermore, for each attribute of a person, there may be a plurality of models in which a relationship between an expression in a content and an expression obtained by rephrasing the expression so as not to cause a person having the attribute to have a negative feeling is learned.

In one example, the generation unit 140 inputs information indicating an expression that is predicted by the prediction unit 130 and that may cause a person having a specific attribute to have a negative feeling and information indicating the attribute to a trained model that has learned a relationship between an attribute of a person and an expression in a content, and an expression obtained by rephrasing the expression so as not to cause the person having the attribute to have a negative feeling.

Subsequently, the generation unit 140 acquires information that is output from the trained model and that indicates the expression rephrased so as not to cause the person having the specific attribute to have a negative feeling.

A method by which the generation unit 140 generates an improvement proposal is not limited to the method exemplified here. For example, the generation unit 140 may input an expression in a content to a generative AI, and may cause the generative AI to rephrase the input expression into an expression that does not cause a person having a specific attribute to have a negative feeling.

The generation unit 140 may further apply the processing of the selection unit 120, the prediction unit 130, and the generation unit 140 to the expression output by the trained model.

With this configuration, a possibility that an expression causes a negative feeling can be further reduced. The reason for this is that, even in a case in which an expression in an improvement proposal is an expression that may cause a negative feeling, an improvement proposal of the expression can be generated.

Next, the output unit 150 will be described.

The output unit 150 outputs information regarding the improvement proposal. For example, the output unit 150 outputs, to the terminal device 20, a display for prompting correction of an expression, information indicating an expression to be improved, and information indicating an improvement proposal.

In one example, the output unit 150 outputs, to the terminal device 20, an instruction to display the display for prompting correction of an expression, the information indicating an expression to be improved, and the information indicating an improvement proposal.

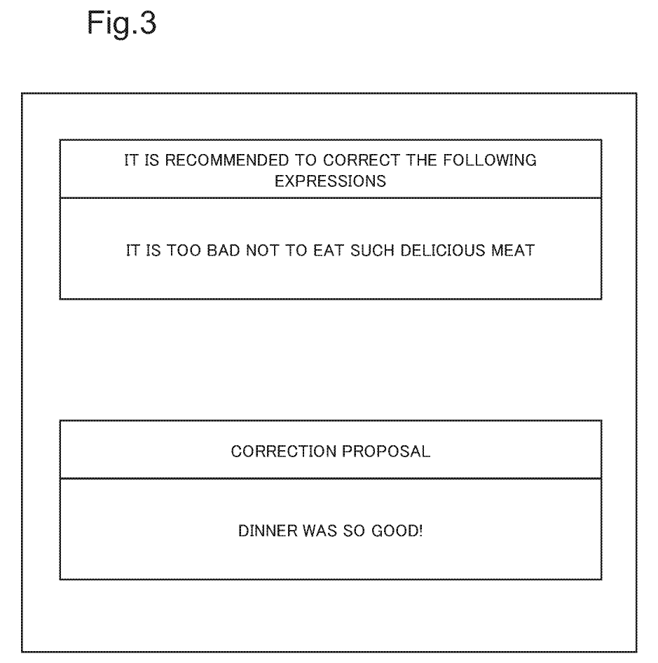

FIG. 3 is an example of a screen displayed by the terminal device 20 based on an instruction from the output unit 150 in the present disclosure. For example, the terminal device 20 displays, as information regarding an improvement proposal, the display for prompting correction of an expression, the information indicating an expression to be improved, and the information indicating an improvement proposal.

In one example, in FIG. 3, a character string “It is recommended to correct the following expression” is displayed as the display for prompting correction of an expression. An example of the display for prompting correction of an expression is not limited to that exemplified here.

In addition, in one example, in FIG. 3, a character string “It is too bad not to eat such delicious meat” is displayed as the information indicating an expression to be improved. The information indicating an expression to be improved is not limited to the information exemplified here.

In addition, in one example, in FIG. 3, a character string “Dinner was so good!” is displayed as the information indicating an improvement proposal. The information indicating an improvement proposal is not limited to the information exemplified here.

The output unit 150 may further output information indicating a reaction to an expression.

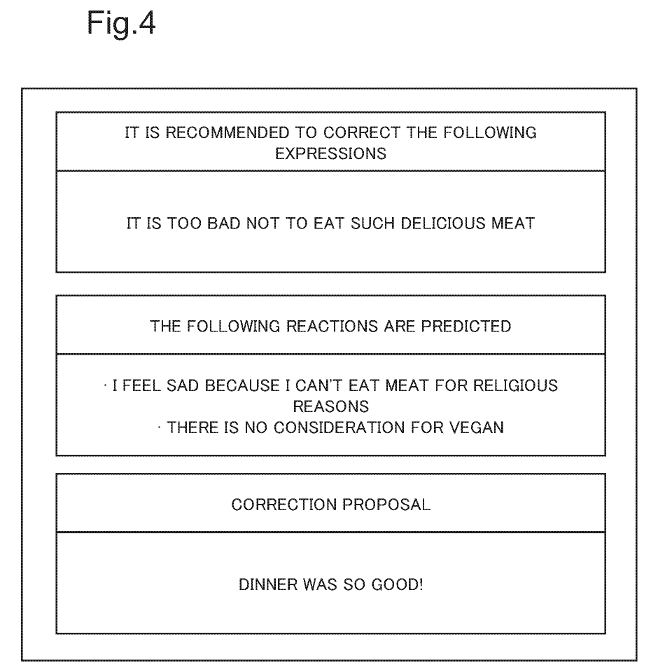

FIG. 4 is an example of a screen displayed by the terminal device 20 based on an instruction from the output unit 150 in the present disclosure. For example, the terminal device 20 displays information regarding an improvement proposal and information indicating a reaction to an expression. Here, the information regarding an improvement proposal and the information indicating a reaction to an expression are predicted by a persona model in one example.

In one example, in FIG. 4, a character string “I feel sad because I can't eat meat for religious reasons” and a character string “There is no consideration for a vegan” are displayed as the information indicating a reaction to an expression. The information indicating a reaction to an expression is not limited to the information exemplified here.

In the case of outputting the information indicating a reaction to an expression, the output unit 150 may output information regarding a subject of the reaction.

Here, a subject of a reaction is, for example, a person having a specific attribute and a person who reacts on the assumption of the person.

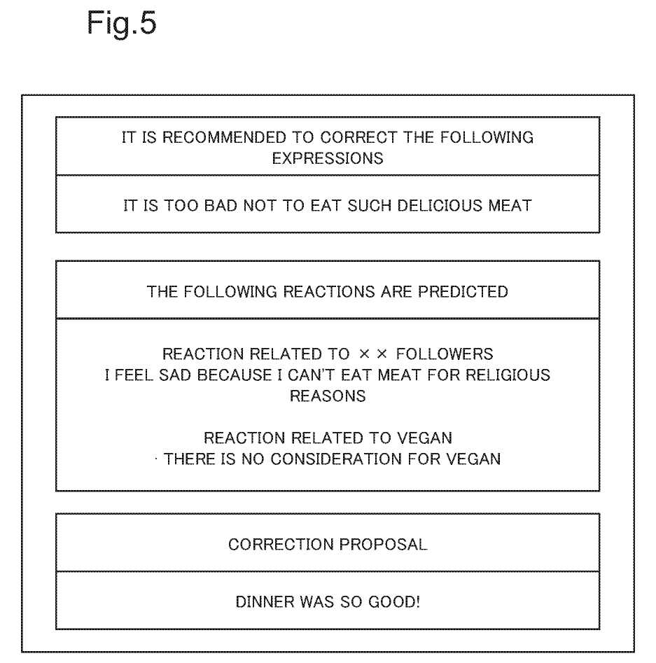

FIG. 5 is an example of a screen displayed by the terminal device 20 based on an instruction from the output unit 150 in the present disclosure. For example, in addition to the content of FIG. 5, the terminal device 20 displays information indicating a subject of a reaction to an expression in association with information indicating the expression.

In one example, in FIG. 5, as the information indicating a subject of a reaction to an expression, a character string “Reaction related to xxx followers” is displayed in the vicinity of information indicating the expression “I feel sad because I can't eat meat for religious reasons”. In one example, in FIG. 5, as the information indicating a subject of a reaction to an expression, a character string “Reaction related to a vegan” is displayed in the vicinity of the information indicating the expression “There is no consideration for a vegan”. Information indicating a subject of a reaction to an expression and an aspect of displaying the information are not limited to those exemplified here.

### Operation Example

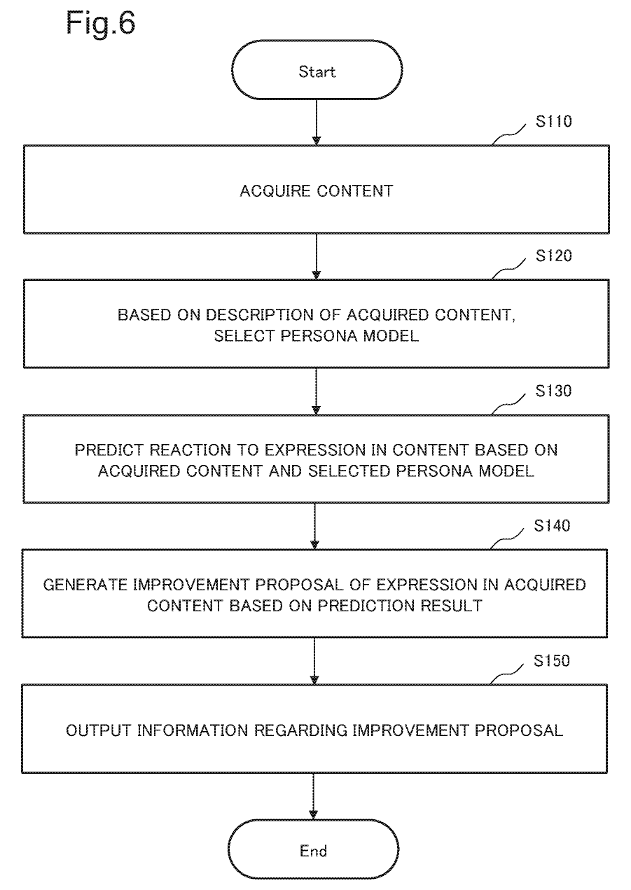

Hereinafter, an operation example of the communication support device 100 will be described with reference to FIG. 6. FIG. 6 is a flowchart illustrating an example of the operation of the communication support device 100 according to the present disclosure.

First, the acquisition unit 110 acquires a content (S110). For example, the acquisition unit 110 acquires a content from the terminal device 20.

Next, the selection unit 120 selects a persona model based on the acquired content (S120). For example, the selection unit 120 calculates, based on the description of the content, a degree of fitness of the content with respect to the persona model for each of persona models, and selects the persona model based on the degree of fitness.

Next, the prediction unit 130 predicts a reaction to an expression in the content based on the acquired content and the selected persona model (S130). For example, the prediction unit 130 inputs a content to a persona model selected by the selection unit 120, and predicts a reaction of a person having a specific attribute in response to an expression in the content.

Next, the generation unit 140 generates an improvement proposal of the expression in the content based on the prediction result (S140). For example, the generation unit 140 generates an improvement proposal by inputting the prediction result of the prediction unit 130 into a trained model that has learned a relationship between an attribute of a person and an expression in the content, and an expression obtained by rephrasing the expression so as not to cause the person having the attribute to have a negative feeling.

Next, the output unit 150 outputs information regarding the improvement proposal (S150). For example, the output unit 150 outputs a display for prompting correction of an expression that may cause a negative feeling, information indicating the expression, and information indicating an improvement proposal of the expression to the terminal device 20.

The first example embodiment has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

### Use Examples

Hereinafter, specific use examples of the communication support device 100 will be described.

### First Use Example

The communication support device 100 can be used, for example, to improve an expression in a post or advertisement on the SNS and an expression in press releases.

### Second Use Example

Furthermore, the communication support device 100 can be used, for example, in an educational site. Hereinafter, a specific example in a case in which the communication support device 100 is used in an educational site will be described.

The acquisition unit 110 acquires a content. Here, in one example, the content is at least one of a report submitted by a student, a composition submitted by a student, a question sentence of a test for a student, a handout to a student, and a handout to a guardian of a student. Examples of the content are not limited to those exemplified here.

The selection unit 120 selects a persona model based on the description of an acquired content.

The prediction unit 130 predicts a reaction to an expression in the content based on the acquired content and the selected persona model.

In one example, the persona model is a learning model that has learned a relationship between an expression and a feeling produced by a person having the attribute in response to the use of the expression.

Furthermore, in one example, the persona model is a learning model that has learned a relationship between an expression and a reaction obtained by assuming a person having a specific attribute in response to the use of the expression.

In one example, the persona model is a learning model that has learned a relationship between a character and whether the character is understandable by a student at a specific learning stage. The character may be katakana, hiragana, or Chinese characters, and may be romaji or another character.

As a specific example, the persona model is a learning model that has learned a relationship between Chinese characters and whether the Chinese characters are understandable by a third-grade student in elementary school.

Furthermore, the persona model is, for example, a learning model that has learned a relationship between a word and whether the word is understandable by a student at a specific learning stage. The word may be a Japanese word, an English word, or a word in another language.

As a specific example, the persona model is a learning model that has learned a relationship between an English word and whether the English word is understandable by a second-grade student in middle school.

The generation unit 140 generates an improvement proposal of an expression in a content based on the prediction result.

The output unit 150 outputs information regarding the improvement proposal.

By using the communication support device 100 in the educational site, for example, the following effects can be expected.

In a case in which a content submitted by a student includes an expression that may give a negative feeling to others, the communication support device 100 can provide information serving as a reference for giving an instruction to the student.

Furthermore, the communication support device 100 can provide information serving as a reference for improving an expression in a content to be provided to a student to an appropriate expression in accordance with a learning stage of the student.

Furthermore, in a case in which a content to be provided to a student and a guardian of the student includes an expression that may give a negative feeling to others, the communication support device 100 can provide information serving as a reference for improving the expression.

### Third Use Example

Furthermore, the communication support device 100 can be used, for example, in a medical site. Hereinafter, a specific example in a case in which the communication support device 100 is used in a medical site will be described.

The acquisition unit 110 acquires a content. Here, in one example, the content is a content transmitted from a doctor to a patient and is at least one of an e-mail and an SNS message. Examples of the content are not limited to those exemplified here.

The selection unit 120 selects a persona model based on the description of an acquired content.

The prediction unit 130 predicts a reaction to an expression in the content based on the acquired content and the selected persona model.

The persona model is, for example, a learning model that has learned a relationship between an expression and a feeling produced by a patient having a specific symptom in response to the use of the expression.

In one example, the persona model is a learning model that has learned a relationship between an expression and a feeling produced by a person suffering from a specific disease in response to the use of the expression.

As a specific example, the persona model is a learning model that has learned a relationship between an expression and a feeling produced by a person suffering from a mental disease in response to the use of the expression.

Furthermore, in one example, the persona model is a learning model that has learned a relationship between an expression and a feeling produced by a person having a specific degree of progression of a specific disease in response to the use of the expression.

As a specific example, the persona model is a learning model that has learned a relationship between an expression and a feeling produced by a person at stage 4 of cancer in response to the use of the expression.

Furthermore, in one example, the persona model is a learning model that has learned a relationship between an expression and a feeling produced by a person having a specific injury in response to the use of the expression.

As a specific example, the persona model is a learning model that has learned a relationship between an expression and a feeling produced by a person whose face is burned in response to the use of the expression.

Furthermore, in one example, the persona model is a learning model that has learned a relationship between an expression and a reaction obtained by assuming a person having a specific attribute in response to the use of the expression. Here, the person having a specific attribute may be a person suffering from a specific disease, a person having a specific degree of progression of a specific disease, a person having a specific injury, or the like, and is not limited to those exemplified herein.

The generation unit 140 generates an improvement proposal of an expression in a content based on the prediction result.

The output unit 150 outputs information regarding the improvement proposal.

Furthermore, in a case in which a content to be provided to a patient includes an expression that may cause a patient having a specific symptom to have a negative feeling, the communication support device 100 can provide information serving as a reference for improving the expression.

Although the specific use examples of the communication support device 100 have been described above, the use examples of the communication support device 100 are not limited to those exemplified here.

### First Modification

A modification of the communication support device 100 will be described. The present modification is an example of a case in which the communication support device 100 uses information indicating an attribute of a recipient of a content. The present modification may be applied not only to the first example embodiment but also to other modifications as long as no contradiction occurs.

First, the acquisition unit 110 will be described.

The acquisition unit 110 acquires a content. Furthermore, the acquisition unit 110 acquires information regarding a recipient of the content. For example, the acquisition unit 110 acquires information regarding a recipient of the content from the terminal device 20.

Here, the information regarding a recipient of a content is, for example, information indicating an attribute of a recipient of a content.

Furthermore, the information regarding a recipient of a content is, for example, information indicating a recipient of a content. In one example, the information indicating a recipient of a content is at least one of a name, a handle name, an identifier, and an e-mail address of the recipient of the content. Examples of the information indicating a recipient of a content are not limited to those exemplified here.

In one example, in a case in which an operation to transmit or publish a content is performed on the terminal device 20, the acquisition unit 110 acquires the information indicating a recipient of a content from the terminal device 20.

Subsequently, the acquisition unit 110 uses the information indicating a recipient of a content to acquire information indicating an attribute of the recipient of the content from a database in which the information indicating the recipient of the content and the information indicating the attribute of the recipient of the content are recorded in association with each other.

The acquisition unit 110 may receive input of the information indicating the attribute of the recipient of the content from the terminal device 20.

Next, the selection unit 120 will be described.

The selection unit 120 selects a persona model based on the information indicating an attribute of a recipient of a content. For example, the selection unit 120 selects a persona model that has learned a relationship between an expression and a reaction produced by a person having an attribute of a recipient of a content in response to the expression.

Since the operations of the prediction unit 130 and the generation unit 140 are similar to those of the first example embodiment, the description thereof will be omitted here.

Next, the output unit 150 will be described.

The output unit 150 outputs information regarding an improvement proposal of an expression in association with an attribute of a recipient of a content.

In one example, the output unit 150 acquires information indicating an attribute of a recipient of a content from a storage device (not illustrated) included in the communication support device 100.

Subsequently, the output unit 150 outputs, to the terminal device 20, an instruction to display information regarding an improvement proposal of an expression in association with the information indicating an attribute of a recipient of a content.

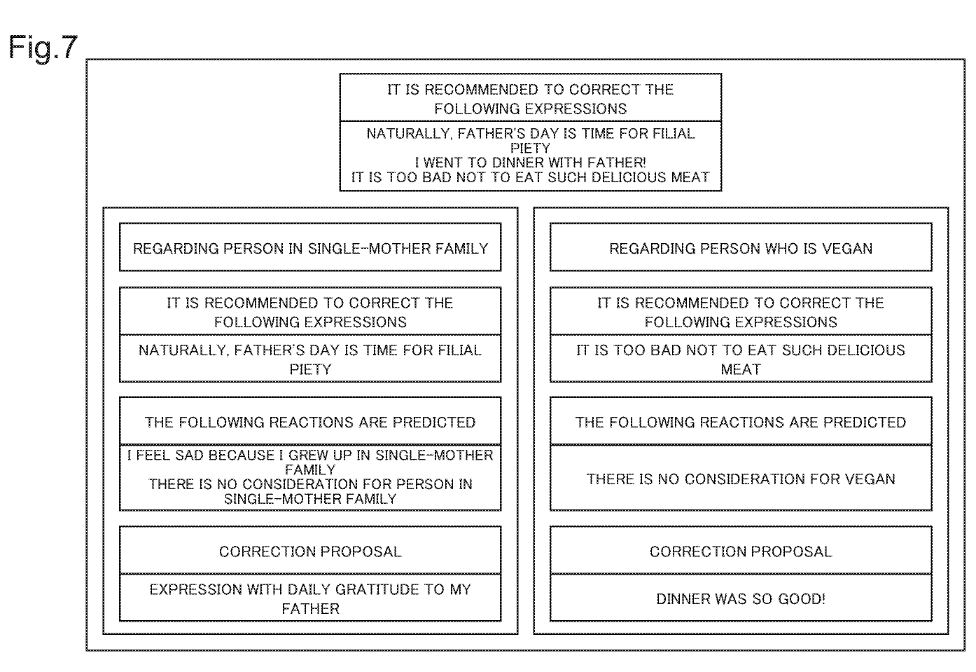

FIG. 7 is an example of a screen displayed by the terminal device 20 based on an instruction from the output unit 150 in the present disclosure. For example, the terminal device 20 displays the information regarding an improvement proposal of an expression in association with the information indicating an attribute of a recipient of a content. FIG. 7 is an example of a case of using a persona model that has learned a reaction of a person having a “single-mother family” as an attribute and a persona model that has learned a reaction of a person having a “vegan” as an attribute.

In one example, in FIG. 7, as the information indicating an attribute of a recipient of a content, a character string “Regarding a person in a single-mother family” and a character string “Regarding a person who is a vegan” are displayed. In addition, under the character string “regarding a person in a single-mother family” indicating an attribute of a recipient of a content, information regarding an improvement proposal of an expression “Naturally, Father's Day is a time for filial piety!”, from which a reaction of the person having the above-mentioned attribute is predicted, is displayed. In addition, under the character string “Regarding a person who is a vegan” indicating an attribute of a recipient of a content, information regarding an improvement proposal of an expression “It is too bad not to eat such delicious meat”, from which a reaction of the person having the above-mentioned attribute is predicted, is displayed.

The communication support device 100 may be configured such that the selection unit 120 selects a persona model based on information indicating an attribute of a recipient of a content, and the output unit 150 does not output information regarding an improvement proposal of an expression in association with the information indicating an attribute of a recipient of a content.

Furthermore, the communication support device 100 may be configured such that the selection unit 120 does not select a persona model based on information indicating an attribute of a recipient of a content, and the output unit 150 outputs information regarding an improvement proposal of an expression in association with the information indicating an attribute of a recipient of a content.

The first modification has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

Furthermore, the communication support device 100 can appropriately select a persona model. The reason for this is that the communication support device 100 selects the persona model based on an attribute of a recipient of a content.

### Second Modification

A modification of the communication support device 100 will be described. The present modification is an example of a case in which the communication support device 100 performs output based on the description of a content. The present modification may be applied not only to the first example embodiment but also to other modifications as long as no contradiction occurs.

The output unit 150 outputs information regarding an improvement proposal in association with information indicating a topic of a content.

In one example, the output unit 150 extracts, for each expression to be improved, at least one of keywords included in the expression as the information indicating a topic of a content. Here, the keyword is a keyword associated with a persona model.

Subsequently, the output unit 150 outputs, to the terminal device 20, an instruction to display the information regarding an improvement proposal of an expression in association with the information indicating a topic of a content.

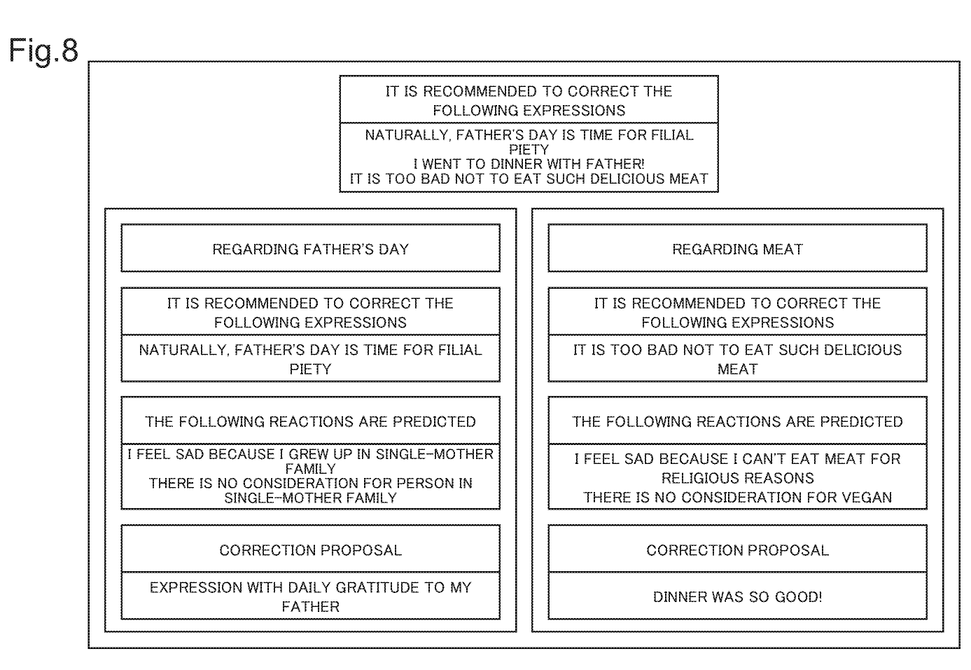

FIG. 8 is an example of a screen displayed by the terminal device 20 based on an instruction from the output unit 150 in the present disclosure. For example, the terminal device 20 displays the information regarding an improvement proposal of an expression in association with the information indicating a topic of a content.

In one example, in FIG. 8, a character string “Regarding Father's Day” and a character string “Regarding meat” are displayed as the information indicating a topic of a content. Furthermore, under the character string “Regarding Father's Day” indicating a topic of a content, information regarding an improvement proposal of an expression “Naturally, Father's Day is a time for filial piety!” corresponding to the topic is displayed. In addition, under the character string “Regarding meat” indicating a topic of a content, information regarding an improvement proposal of an expression “It is too bad not to eat such delicious meat” corresponding to the topic is displayed. An aspect of displaying the information indicating a topic of a content and the information regarding an improvement proposal is not limited to those exemplified here.

The second modification has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

Furthermore, the communication support device 100 can clearly indicate the purpose of correction to a sender of a content. The reason for this is that the communication support device 100 outputs an improvement proposal for each content.

### Third Modification

A modification of the communication support device 100 will be described. The present modification is an example of a case in which the communication support device 100 performs output based on a degree of fitness of a content with respect to a persona model. The present modification may be applied not only to the first example embodiment but also to other modifications as long as no contradiction occurs.

The selection unit 120 calculates a degree of fitness of a persona model with respect to a content based on an acquired keyword related to the content and a keyword associated with the persona model. Since an example of a specific calculation method is similar to that of the first example embodiment, and the description thereof will be omitted here.

The output unit 150 outputs information regarding an improvement proposal based on a degree of fitness of a persona model with respect to a content.

In one example, the output unit 150 aggregates the degrees of fitness of persona models that have performed prediction regarding the expression for each expression to be improved with respect to a content.

Subsequently, regarding the expression to be improved, in a case in which a persona model, the degree of fitness of which is equal to or more than a second threshold value, is included in the persona models that have performed prediction regarding the expression, the output unit 150 sets an improvement proposal of the expression as an improvement proposal having high relevance to a topic. In addition, regarding the expression to be improved, in a case in which the degree of fitness of any persona model that has performed prediction regarding the expression is less than the second threshold value, the output unit 150 sets an improvement proposal of the expression as an improvement proposal having low relevance to a topic. The second threshold value is a threshold value different from a threshold value used when the selection unit 120 selects the persona model.

Subsequently, the output unit 150 outputs, to the terminal device 20, an instruction to display the information regarding an improvement proposal of an expression in association with information indicating relevance between the improvement proposal and the topic.

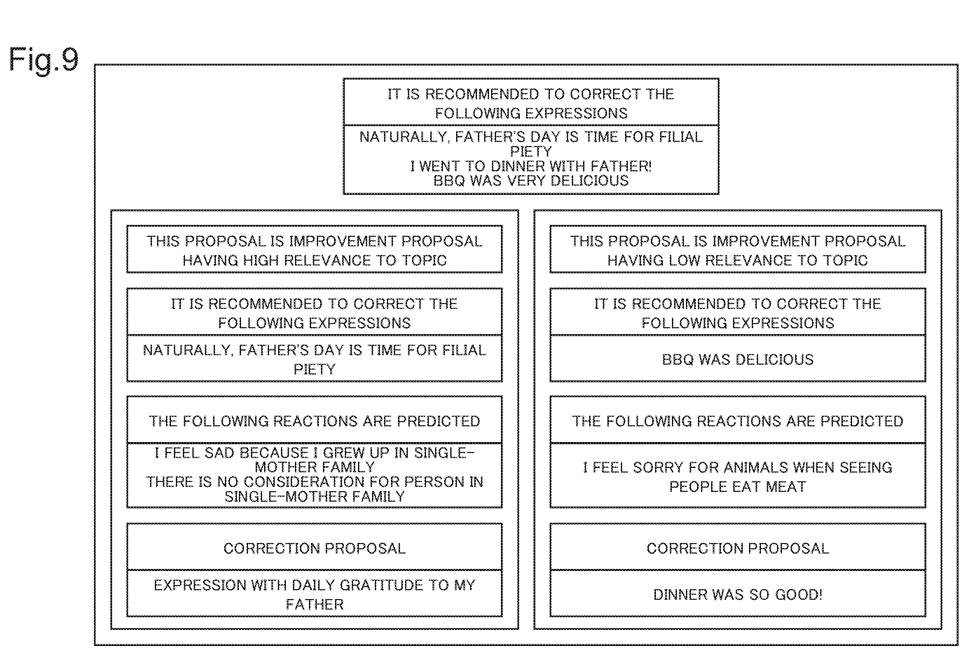

FIG. 9 is an example of a screen displayed by the terminal device 20 based on an instruction from the output unit 150 in the present disclosure. For example, the terminal device 20 displays information regarding an improvement proposal of an expression in association with information indicating relevance between the improvement proposal and the topic.

In one example, in FIG. 9, as the information indicating relevance between an improvement proposal and a topic, a character string “This proposal is an improvement proposal having high relevance to a topic” and a character string “This proposal is an improvement proposal having low relevance to a topic” are displayed. An aspect of outputting the information indicating relevance between an improvement proposal and a topic is not limited to the aspect exemplified here.

Furthermore, the information regarding an improvement proposal of the expression is displayed under the character string “This proposal is an improvement proposal having high relevance to a topic” indicating the relevance between the improvement proposal and the topic. Here, the information regarding an improvement proposal, which is displayed under the character string “This proposal is an improvement proposal having high relevance to a topic” indicating the relevance between the improvement proposal and the topic, is based on at least information output by a persona model, the degree of fitness of which is equal to or more than the threshold value. An aspect of displaying the information indicating the relevance between the improvement proposal and the topic and the information regarding the improvement proposal in association with each other is not limited to the aspect exemplified herein.

Furthermore, the information regarding an improvement proposal of the expression is displayed under the character string “This proposal is an improvement proposal having low relevance to a topic” indicating the relevance between the improvement proposal and the topic. Here, the information regarding an improvement proposal, which is displayed under the character string “This proposal is an improvement proposal having low relevance to a topic” indicating the relevance between the improvement proposal and the topic, is based on information output by a persona model, the degree of fitness of which is less than the threshold value. An aspect of displaying the information indicating the relevance between the improvement proposal and the topic and the information regarding the improvement proposal in association with each other is not limited to the aspect exemplified herein.

The third modification has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

Furthermore, the communication support device 100 can present a material for determining the necessity of correction of an expression to a sender of a content. The reason for this is that the communication support device 100 outputs information indicating the relevance between the topic and the improvement proposal.

### Fourth Modification

A modification of the communication support device 100 will be described. The present modification is an example in which the communication support device 100 evaluates a degree of risk in a case in which an expression is used. The present modification may be applied not only to the first example embodiment but also to other modifications as long as no contradiction occurs.

First, the generation unit 140 will be described.

The generation unit 140 generates an improvement proposal of an expression in a content based on the prediction result. The generation unit 140 further evaluates a degree of risk in a case in which an expression that may cause a person having a specific attribute to have a negative feeling is used. For example, the generation unit 140 inputs a relationship between an expression that may cause a person having a specific attribute to have a negative feeling and a scale of a reaction to the expression in the past to a trained model that has learned the relationship, thereby evaluating a degree of risk in a case in which the expression is used.

Here, the scale of the reaction to the expression in the past is, for example, the number of reactions to the expression in the past. In one example, the number of reactions to the expression is the number of times that a post including a content that criticizes the expression is made on an SNS. Furthermore, in one example, the number of reactions to the expression is the number of times of browsing a web page including a content that criticizes the expression. Furthermore, in one example, the number of reactions to the expression is the number of times that a news report including a content that criticizes the expression is made on a television program. Furthermore, in one example, the number of reactions to the expression is the number of times of receiving mails and calls including a content that criticizes the expression. Examples of the number of reactions to the expression are not limited to those exemplified here.

In addition, the scale of a reaction to an expression is, for example, a length of a period during which the reaction to the expression was made in the past. In one example, the length of the period during which a reaction to an expression is made is a period during which a post including a content that criticizes the expression is made on an SNS.

Furthermore, in one example, the length of the period during which a reaction to an expression is made is a period during which a news report including a content that criticizes the expression is made on a television program. Examples of the length of the period during which a reaction to an expression is made are not limited to those exemplified here.

In one example, the generation unit 140 calculates, based on the number of reactions to an expression in the past, a score indicating a degree of risk in a case in which the expression is used. The generation unit 140 sets a total value of values obtained by multiplying the number of reactions by a predetermined coefficient for each type of reaction as the score indicating a degree of risk in a case in which the expression is used. The predetermined coefficient is appropriately set according to the social influence of a reaction or the like.

As a specific example, a description will be given as to a case in which a post including a content that criticizes an expression is made 10000 times on an SNS, and a news report including a content that criticizes the expression is made 3 times on a television program. Here, a coefficient of the post on the SNS is set to 1, and a coefficient of the news report on the television program is set to 1000. In this case, a score of the post on the SNS is 10,000, a score of the news report on the television program is 3000, and a score indicating a degree of risk in the case of using the expression is 13000, which is the total value of the respective scores. An example of a score calculation method is not limited to the score calculation method exemplified here.

Subsequently, the generation unit 140 sets an expression whose score indicating a degree of risk is equal to or more than a threshold value as an expression having a high possibility of being criticized. In addition, the generation unit 140 sets an expression whose score indicating a degree of risk is less than the threshold value as an expression having a low possibility of being criticized. The threshold value is appropriately set. In addition, the generation unit 140 may set a plurality of threshold values and may evaluate a degree of risk in a plurality of stages.

Next, the output unit 150 will be described.

The output unit 150 outputs information regarding an improvement proposal of an expression in association with information indicating a degree of risk in a case in which the expression is used.

In one example, the output unit 150 outputs, to the terminal device 20, an instruction to display the information regarding an improvement proposal of an expression in association with the information indicating a degree of risk in a case in which the expression is used.

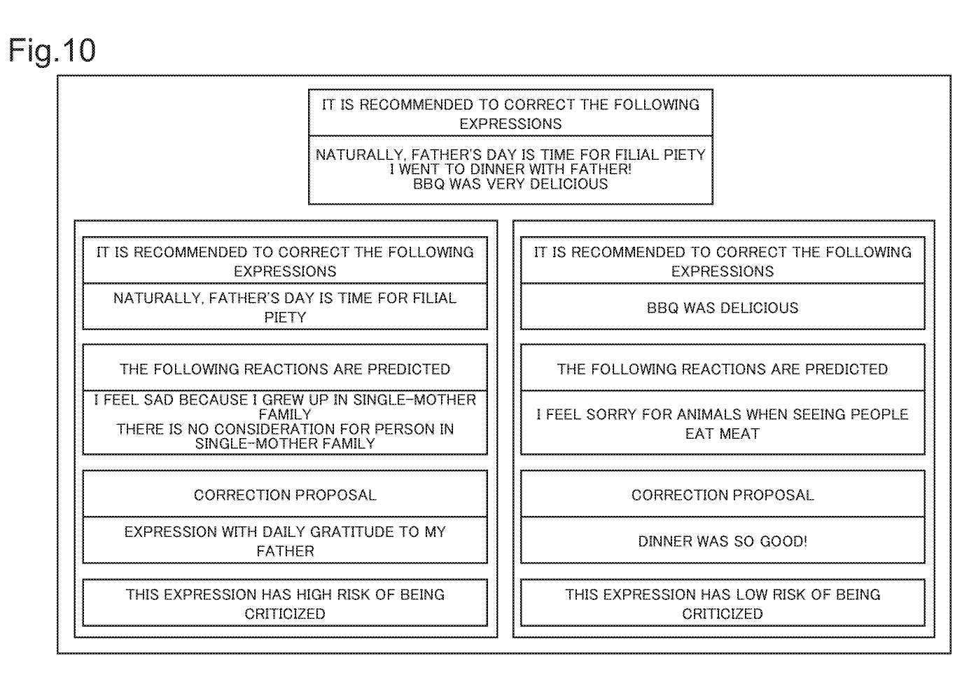

FIG. 10 is an example of a screen displayed by the terminal device 20 based on an instruction from the output unit 150 in the present disclosure. For example, the terminal device 20 displays the information regarding an improvement proposal of an expression in association with the information indicating a degree of risk in a case in which the expression is used.

In one example, in FIG. 10, a character string “An expression is an expression having a high risk of being criticized” and a character string “An expression is an expression having a low risk of being criticized” are displayed as the information indicating a degree of risk in a case in which the expression is used.

Furthermore, the character string “An expression is an expression having a high risk of being criticized” indicating the degree of risk in a case in which the expression is used is displayed under the information regarding an improvement proposal of the expression. An aspect of displaying the information indicating the degree of risk in a case in which the expression is used and the information regarding the improvement proposal in association with each other is not limited to the aspect exemplified here.

Furthermore, the character string “This is an expression having a low risk of being criticized” indicating the degree of risk in a case in which the expression is used is displayed under the information regarding an improvement proposal of the expression. An aspect of displaying the information indicating the degree of risk in a case in which the expression is used and the information regarding the improvement proposal in association with each other is not limited to the aspect exemplified here.

The output unit 150 may further output information indicating a scale of a reaction to an expression in the past.

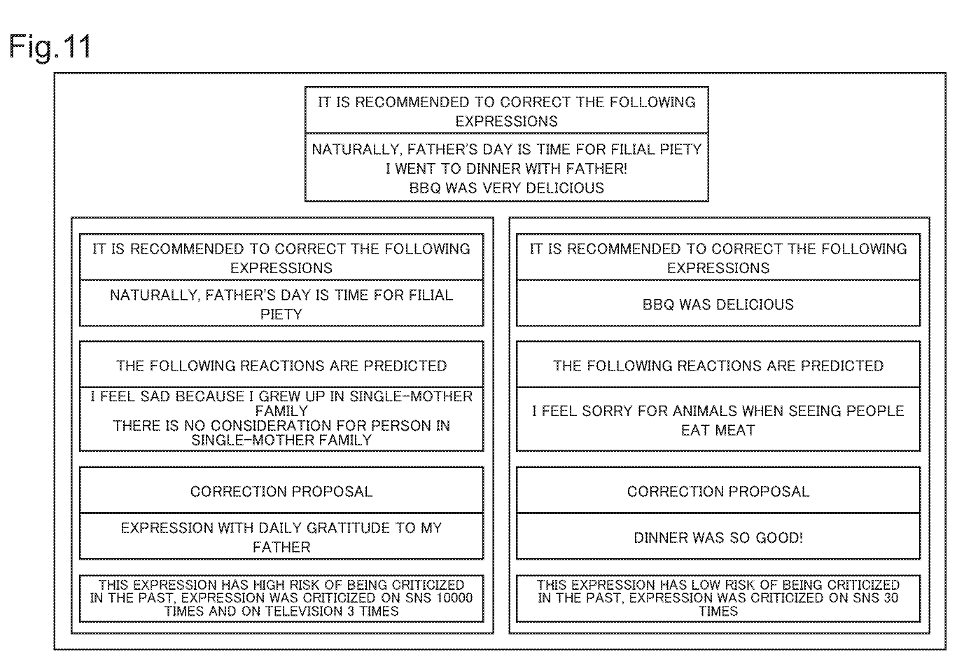

FIG. 11 is an example of a screen displayed by the terminal device 20 based on an instruction from the output unit 150 in the present disclosure. For example, in addition to the example in FIG. 10, the terminal device 20 displays the information indicating a scale of a reaction to an expression in association with the information regarding an improvement proposal of the expression.

In one example, in FIG. 11, a character string “In the past, the expression was criticized on the SNS 10000 times and was criticized on the television 3 times” and a character string “In the past, the expression was criticized on the SNS 30 times” are displayed as the information indicating a scale of a reaction to an expression. An aspect of displaying the information indicating a scale of a reaction to an expression is not limited to the aspect exemplified here.

The output unit 150 may not display the information regarding an improvement proposal of an expression whose score indicating a degree of risk is less than the threshold value.

The fourth modification has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

Furthermore, the communication support device 100 can present a material for determining the necessity of correction of an expression to a sender of a content. The reason for this is that the communication support device 100 outputs information indicating a scale of a reaction made to an expression in the past.

### Fifth Modification

A modification of the communication support device 100 will be described. The present modification is an example in which the communication support device 100 receives selection of a persona model from a user. The present modification may be applied not only to the first example embodiment but also to other modifications as long as no contradiction occurs.

The selection unit 120 selects a persona model based on the acquired content. For example, the selection unit 120 calculates, based on the description of the content, a degree of fitness of the content with respect to the persona model for each persona model, and extracts the persona model based on the degree of fitness. Further, the selection unit 120 outputs information indicating the extracted persona model to the terminal device 20, and receives selection of at least one persona model from the user. The selection unit 120 selects the selected persona model as a persona model to be applied to the content.

That is, the selection unit 120 extracts persona models based on the description of the acquired content, receives, from the user, selection of a persona model to be applied to the content among the extracted persona models, and selects the persona model that has received the selection as a persona model to be applied to the content.

In one example, the selection unit 120 compares keywords included in an acquired content with keywords associated with a persona model. The selection unit 120 aggregates the number of keywords associated with the persona model that are included in a content. The selection unit 120 sets the number of keywords associated with the persona model that are included in the content as a degree of fitness of the persona model with respect to the content. Here, in one example, the number of keywords may be the number of times keywords appear in the content, or may be types of keywords included in the content.

Subsequently, the selection unit 120 extracts a persona model whose degree of fitness with respect to a content is equal to or more than a threshold value as a persona model that receives selection from the user. The threshold value is appropriately set.

Here, the specific method of extracting a persona model using the selection unit 120 may be similar to the method of selecting a persona model to be applied to a content using the selection unit 120 in the first example embodiment.

Subsequently, the selection unit 120 outputs, to the terminal device 20, an instruction to display information indicating the extracted persona model and a display for receiving selection of the persona model. Instead of the selection unit 120, the output unit 150 may output, to the terminal device 20, the instruction to display the information indicating the extracted persona model and the display for receiving selection of the persona model.

Subsequently, in a case in which the terminal device 20 receives an operation of selecting a persona model, the selection unit 120 selects the selected persona model as a persona model to be applied to the content.

The fifth modification has been described above. The communication support device 100 can propose an improvement proposal of an expression in a content in consideration of a feeling of a recipient with respect to the content. The reason for this is that the communication support device 100 predicts reactions of people having various attributes in response to expressions in contents and generates improvement proposals of the expressions.

### Hardware Configuration

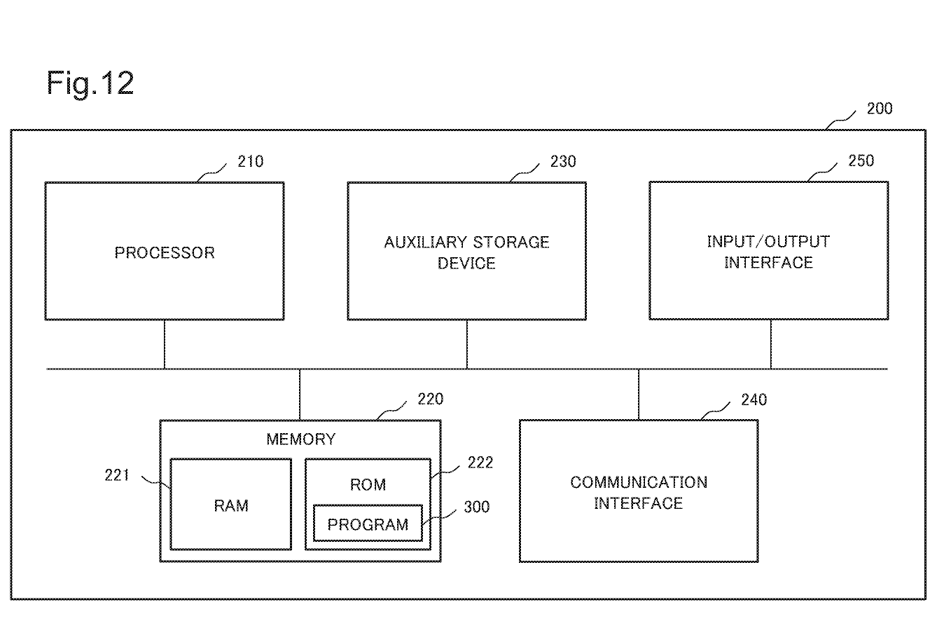

Hardware forming each of the communication support devices will be described. FIG. 12 is a block diagram illustrating an example of a hardware configuration of a computer 200 that implements the communication support device 100 according to the present disclosure. The computer 200 includes a processor 210, a memory 220, an auxiliary storage device 230, a communication interface 240, and an input/output interface 250. The memory 220 includes a random access memory (RAM) 221 and a read only memory (ROM) 222. The computer 200 implements the procedures described in each of the above example embodiments by executing a program 300 that implements a function as the communication support device 100.

In one example, the processor 210 executes the program 300 using the RAM 221.

In one example, the processor 210 is at least one of a central processing unit (CPU) and a graphics processing unit (GPU). The processor 210 may be other various processors, and is not limited to those exemplified here.

Here, the program 300 is a program that causes a computer to function as each unit of the device described in each of the example embodiments.

The program 300 may be recorded in the ROM 222 or may be stored in the auxiliary storage device 230.

The communication interface 240 communicates with an external device.

The input/output interface 250 is connected to a device that receives an input of information to the communication support device and a device that outputs information from the communication support device.

The function of each unit of the device described in each of the example embodiments is implemented by the processor 210 executing the program 300. The processor 210 may implement the function of each unit of the device described in each of the example embodiments by reading a program or data stored in a recording medium attached to a drive device or the like into the RAM.

A processing method of causing a recording medium to record a program for implementing each configuration in the function of each example embodiment, reading the program recorded in the recording medium, and causing a computer to execute the program is also included in the scope of each example embodiment. In addition, a computer-readable recording medium in which the program is recorded and the program itself are also included in the scope of each example embodiment.

The configuration described as a single device in the above-described example embodiment may be provided in a plurality of devices in a distributed manner. For example, the communication support device 100 may be implemented by a plurality of computer devices using a cloud computing technology or the like.

As described above, the present disclosure has been described using the above-described example embodiments and modifications as exemplary examples. However, the present disclosure is not limited to these example embodiments and modifications. The present disclosure may include example embodiments to which various modifications or applications that can be grasped by so-called persons skilled in the art are applied within the scope of the present disclosure. The present disclosure may include example embodiments in which matters described in the present specification are appropriately combined with each other or are replaced as necessary. For example, matters described with a specific example embodiment can be applied to other example embodiments as long as no contradiction occurs.

### Supplementary Note

Some or all of the present disclosure can also be described as the following Supplementary Notes. However, the present disclosure is not necessarily limited to this aspect of the Supplementary Note.

### Supplementary Note 1

A communication support device including:

an acquisition means for acquiring a content;

a selection means for selecting, based on a description of the acquired content, a persona model from among the plurality of persona models, the persona model being a trained model that has learned a relationship between an expression in the content and a reaction of a person having a specific attribute in response to the expression;

a prediction means for predicting, based on the acquired content and the selected persona model, a reaction to the expression in the acquired content;

a generation means for generating, based on a prediction result, an improvement proposal of the expression in the acquired content; and

an output means for outputting information regarding the improvement proposal.

### Supplementary Note 2

The communication support device according to supplementary

note 1, in which the output means outputs a display for prompting correction of the expression, information indicating the expression to be improved, and the improvement proposal.

### Supplementary Note 3

The communication support device according to Supplementary Note 1 or 2, in which

the acquisition means acquires information indicating an attribute of a recipient of the content, and

the output means outputs the information regarding the improvement proposal in association with the information indicating the attribute of the recipient of the content.

### Supplementary Note 4

The communication support device according to Supplementary Note 3, in which the selection means selects the persona model based on the information indicating the attribute of the recipient of the content.

### Supplementary Note 5

The communication support device according to Supplementary Notes 1 to 4, in which the output means outputs the information regarding the improvement proposal in association with information indicating a topic of the content.

### Supplementary Note 6

The communication support device according to Supplementary Notes 1 to 4, in which

the selection means selects, based on a degree of fitness of the persona model with respect to the content, the persona model, the degree of fitness being calculated based on a keyword related to the acquired content and a keyword associated with the persona model, and

the output means outputs, based on the degree of fitness of the persona model with respect to the acquired content, the information regarding the improvement proposal.

### Supplementary Note 7

The communication support device according to Supplementary Notes 1 to 6, in which the persona model is a learning model that has learned a relationship between a character and whether the character is understandable by a student at a specific learning stage.

### Supplementary Note 8

The communication support device according to Supplementary Notes 1 to 6, in which the persona model is a learning model that has learned a relationship between an expression and a feeling produced by a patient having a specific symptom in response to use of the expression.

### Supplementary Note 9

A communication support method including:

acquiring a content;

selecting, based on a description of the acquired content, a persona model from among the plurality of persona models, the persona model being a trained model that has learned a relationship between an expression in the content and a reaction of a person having a specific attribute in response to the expression;

predicting, based on the acquired content and the selected persona model, a reaction to the expression in the acquired content;

generating, based on a prediction result, an improvement proposal of the expression in the acquired content; and

outputting information regarding the improvement proposal.

### Supplementary Note 10

A program causing a computer to execute processing including:

acquiring a content;

selecting, based on a description of the acquired content, a persona model from among the plurality of persona models, the persona model

being a trained model that has learned a relationship between an expression in the content and a reaction of a person having a specific attribute in response to the expression;

predicting, based on the acquired content and the selected persona model, a reaction to the expression in the acquired content;

generating, based on a prediction result, an improvement proposal of the expression in the acquired content; and

outputting information regarding the improvement proposal.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described in the Supplementary Notes can be similarly dependent on not only the Supplementary Notes 1, 9, and 10, but also, without departing from the above-described example embodiments, various pieces of hardware and software, and various recording means or systems for recording software.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A communication support device comprising:
at least one memory storing instructions; and
at least one processor configured to execute the instructions to:
acquire a content;
select, based on a description of the acquired content, a persona model from among the plurality of persona models, the persona model being a trained model that has learned a relationship between an expression in the content and a reaction of a person having a specific attribute in response to the expression;
predict, based on the acquired content and the selected persona model, a reaction to the expression in the acquired content;
generate, based on a prediction result, an improvement proposal of the expression in the acquired content; and
output information regarding the improvement proposal.

2. The communication support device according to claim 1,
wherein the at least one processor is further configured to execute the instructions to:
output a display for prompting correction of the expression, information indicating the expression to be improved, and the improvement proposal.

3. The communication support device according to claim 1,
wherein the at least one processor is further configured to execute the instructions to:
acquire information indicating an attribute of a recipient of the content, and
output the information regarding the improvement proposal in association with the information indicating the attribute of the recipient of the content.

4. The communication support device according to claim 3,
wherein the at least one processor is further configured to execute the instructions to:
select the persona model based on the information indicating the attribute of the recipient of the content.

5. The communication support device according to claim 1,
wherein the at least one processor is further configured to execute the instructions to:
output the information regarding the improvement proposal in association with information indicating a topic of the content.

6. The communication support device according to claim 1,
wherein the at least one processor is further configured to execute the instructions to:
select, based on a degree of fitness of the persona model with respect to the content, the persona model, the degree of fitness being calculated based on a keyword related to the acquired content and a keyword associated with the persona model, and
output, based on the degree of fitness of the persona model with respect to the acquired content, the information regarding the improvement proposal.

7. The communication support device according to claim 1, wherein the persona model is a learning model that has learned a relationship between a character and whether the character is understandable by a student at a specific learning stage.

8. The communication support device according to claim 1, wherein the persona model is a learning model that has learned a relationship between an expression and a feeling produced by a patient having a specific symptom in response to use of the expression.

9. A communication support method comprising:
by a computer,
acquiring a content;
selecting, based on a description of the acquired content, a persona model from among the plurality of persona models, the persona model being a trained model that has learned a relationship between an expression in the content and a reaction of a person having a specific attribute in response to the expression;
predicting, based on the acquired content and the selected persona model, a reaction to the expression in the acquired content;
generating, based on a prediction result, an improvement proposal of the expression in the acquired content; and
outputting information regarding the improvement proposal.

10. A non-transitory recording medium storing a program for causing a computer to execute processing of:
acquiring a content;
selecting, based on a description of the acquired content, a persona model from among the plurality of persona models, the persona model being a trained model that has learned a relationship between an expression in the content and a reaction of a person having a specific attribute in response to the expression;
predicting, based on the acquired content and the selected persona model, a reaction to the expression in the acquired content;
generating, based on a prediction result, an improvement proposal of the expression in the acquired content; and
outputting information regarding the improvement proposal.
